(19) United States
(12) Patent Application Publication
(10) Pub. No.: US 2016/0200027 A1
(43) Pub. Date: Jul. 14, 2016

(54) MOLD FOR RESIN MOLDED PART AND METHOD OF MANUFACTURING RESIN MOLDED PART

(71) Applicant: Koito Manufacturing Co., Ltd., Tokyo (JP)

(72) Inventor: Takeyuki Tachiiwa, Shizuoka-shi (Shizuoka) (JP)

(21) Appl. No.: 14/979,853

(22) Filed: Dec. 28, 2015

(30) Foreign Application Priority Data
Jan. 9, 2015 (JP) 2015-003507

(51) Int. Cl. B29C 49/06

(52) U.S. Cl. CPC B29C 49/06; B29L 2031/3055

(57) ABSTRACT

Provided is a mold for a resin molded part which defines a cavity with a plurality of submolds. The plurality of submolds includes a gate submold including a gate formed therein to inject a molten resin into the cavity; a gas injection submold including a gas injection port formed therein to inject a gas into the cavity; and a core pin submold including a core pin provided to be movable in a retreat direction from the cavity. The core pin submold is arranged such that the core pin faces the gas injection port.

### CROSS-REFERENCE TO RELATED APPLICATIONS

This application is based on and claims priority from Japanese Patent Application No. 2015-003507 filed on Jan. 9, 2015, with the Japan Patent Office, the disclosure of which is incorporated herein in its entirety by reference.

### TECHNICAL FIELD

The present disclosure relates to a resin molded part.

### BACKGROUND

Conventionally, various parts are used in a vehicle lamp such as a headlamp. Further, respective parts are manufactured by various methods depending on their shape or material. In the vehicle lamp such as a headlamp, for example, an aiming device is provided to adjust an optical axis direction which serves as a reference of a light irradiation direction. Further, a part called an aiming screw is provided to adjust the aiming device.

For this type of aiming screw, the whole part may be formed of a metal in order to secure a mechanical strength. However, it has also been suggested to use a resin material from the viewpoint of weight lightening. Meanwhile, since the resin material has a strength inferior to that of the metal, the whole part may be somewhat enlarged in order to secure the strength. In that case, the enlargement reduces the weight lightening effect.

Thus, a mold, which is provided with a core pin to form a cavity in a part of the aiming screw, has been suggested (see, e.g., Japanese Patent Laid-Open Publication No. 2013-082430). In addition, by manufacturing the aiming screw having a cavity using such a mold, the desired strength and the weight lightening of the part itself are compatibly achieved.

### SUMMARY

When it is intended to increase the length of the cavity that is formed inside the part by the core pin according to the lengthening of the part, it is considered to increase the length of the core pin itself. However, since the lengthened core pin is easily broken, there is a limit on lengthening from the viewpoint of a mold design.

The present disclosure has been made in consideration of such a problem, and an object of the present disclosure is to provide a new technique for manufacturing a resin molded part having high hollowness.

In order to solve the above-mentioned problem, according to an exemplary embodiment, the present disclosure provides a mold for a resin molded part which defines a cavity with a plurality of submolds. The plurality of submolds includes a gate submold formed with a gate configured to inject a molten resin into the cavity; a gas injection submold formed with a gas injection port configured to inject a gas into the cavity; and a core pin submold provided with a core pin that is movable in a retreat direction from the cavity. The core pin submold is arranged such that the core pin faces the gas injection port.

According to the exemplary embodiment, when the core pin is moved in the retreat direction from the cavity, a hollow portion formed in the molten resin by the gas expands. Therefore, the hollowness of the resin molded part may be enhanced.

The core pin submold may include a moving mechanism configured to retreat the core pin in a direction spaced apart from the gas injection port and the gate.

The moving mechanism may be configured such that the core pin is retreated by the molten resin injected into the cavity. Accordingly, since the pressure of the molten resin injected into the cavity is available as a force to retreat the core pin, the core pin may be retreated by a simple mechanism.

The gate and the gas injection port may be arranged at one end of the cavity in a length direction according to the shape of the resin molded part, and the core pin may be arranged at the other end thereof.

According to another exemplary embodiment, the present disclosure provides a mold for a resin molded part which defines a cavity with a fixed submold and a movable submold. The fixed submold is provided with a gate configured to inject a molten resin into the cavity, and a gas injection port configured to inject a gas into the cavity. The movable submold is provided with a core pin that is movable in a retreat direction from the cavity. The core pin is arranged to face the gas injection port.

According to the exemplary embodiment, when the core pin is moved in the retreat direction from the cavity, a hollow portion formed in the molten resin by the gas expands. Therefore, the hollowness of the resin molded part may be enhanced.

According to still another exemplary embodiment, the present disclosure provides a method of manufacturing a resin molded part. The method includes a resin injection process of injecting a molten resin into a cavity that is defined with a plurality of submolds; a gas injection process of injecting a gas into the molten resin before the cavity is filled with the molten resin, and a retreat process of retreating at least a part of the core pin in the cavity from the cavity after the gas injection process is started and before the cavity is filled with the molten resin.

According to the exemplary embodiment, when the core pin is moved in the retreat direction from the cavity, a hollow portion formed in the molten resin by the gas expands. Therefore, the hollowness of the resin molded part may be enhanced.

The retreat process may be performed in a situation where the molten resin has fluidity. Accordingly, a hollow portion formed in the molten resin is easily expanded.

According to the present disclosure, a resin molded part having high hollowness may be provided.

The above-described summary is illustration purposes only and does not intend to limit in any ways. In addition to the illustrative embodiment, examples, and features described above, additional embodiment, example, and features will become apparent by referring to the drawings and the following detailed description.

### BRIEF DESCRIPTION OF THE DRAWINGS

FIG. 1 is a vertical cross-sectional view illustrating a vehicle headlamp according to an exemplary embodiment.

FIG. 2 is a side view illustrating an optical axis adjustment screw, which is an example of a resin molded part according to the present exemplary embodiment.

FIG. 3 is a schematic cross-sectional view illustrating the optical axis adjustment screw according to the present exemplary embodiment.

FIG. 4 is a cross-sectional view illustrating a schematic configuration of a mold for the resin molded part according to the present exemplary embodiment.

FIG. 5 is a view illustrating a timing chart in a manufacturing method according to the present exemplary embodiment.

FIG. 6 is a cross-sectional view schematically illustrating a state inside the cavity during injection molding.

FIG. 7 is a cross-sectional view schematically illustrating a state inside the cavity during injection molding.

FIG. 8 is a cross-sectional view schematically illustrating a state inside the cavity during injection molding.

FIG. 9 is a cross-sectional view schematically illustrating a state inside the cavity during injection molding.

FIG. 10 is a cross-sectional view schematically illustrating a state inside the cavity during injection molding.

FIG. 11 is a flowchart illustrating a method of manufacturing a resin molded part according to the present exemplary embodiment.

### DETAILED DESCRIPTION

In the following detailed description, reference is made to the accompanying drawing, which form a part hereof. The illustrative exemplary embodiments described in the detailed description, drawings, and claims are not meant to be limiting. Other exemplary embodiments may be utilized, and other changes may be made, without departing from the spirit or scope of the subject matter presented here.

Hereinafter, exemplary embodiments of the present disclosure will be described with reference to the drawings. The same or similar components, members, or processes in each drawing will be denoted by the same reference numerals, and duplicate descriptions thereof will be omitted. Further, exemplary embodiments are illustrative only without limiting the invention. All features and combinations thereof described in the exemplary embodiments are not necessarily essential to the invention.

(Vehicle Headlamp)

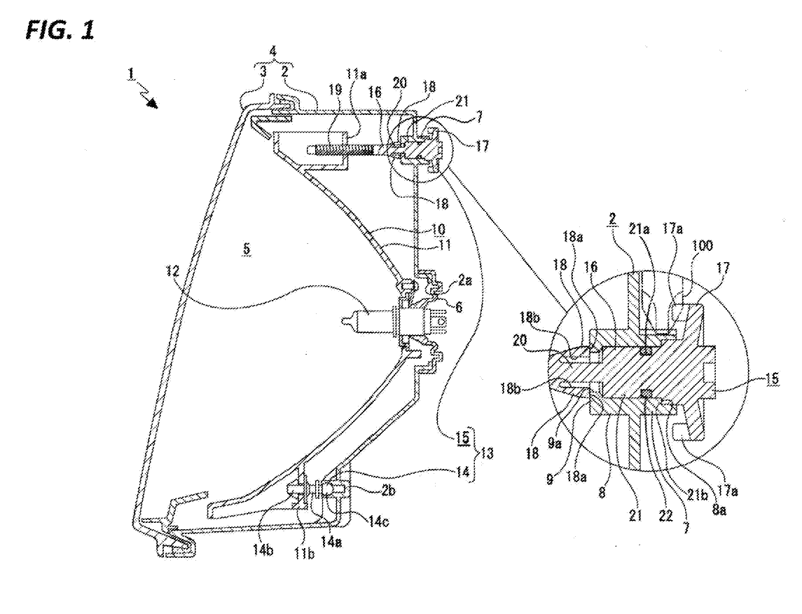

First, descriptions will be made on a vehicle headlamp in which a resin molded part according to the present exemplary embodiment is used. FIG. 1 is a vertical cross-sectional view illustrating a vehicle headlamp 1 according to the present exemplary embodiment. The vehicle headlamp 1 is arranged to be attached at each of left and right sides in a front portion of a vehicle body.

As illustrated in FIG. 1, the vehicle headlamp 1 includes a lamp body 2 that has a front-opened recess, and a cover 3 that closes the opening of the lamp body 2. A lamp outer case 4 is constituted by the lamp body 2 and the cover 3. An internal space of the lamp outer case 4 is formed as a lamp chamber 5.

In a rear end portion of the lamp body 2, a mounting hole 2a is formed to penetrate the rear end portion back and forth. A back cover 6 is attached to the mounting hole 2a.

In the rear end portion of the lamp body 2, screw supports 7, 7 (only one illustrated in FIG. 1) are provided to be separated vertically. Each screw support 7 is constituted with a cylindrical support cylinder 8 that extends back and forth, and a flange 9 that protrudes inward from a front end portion of the support cylinder 8. A restraining surface 8a that faces backward is formed at a position close to a rear end of an inner surface side of the support cylinder 8. An insert hole 9a is formed in the flange 9 to penetrate the flange 9 back and forth.

A pivot supporting portion 2b is provided in a lower end portion of the lamp body 2. A lamp unit 10 is arranged in the lamp chamber 5. The lamp unit 10 is constituted with a reflector 11 and a light source 12 attached to a rear end portion of the reflector 11. Further, the lamp unit 10 is tiltably supported to the lamp body 2 by an optical axis adjustment mechanism 13.

The reflector 11 is provided with thread supporting portions 11a, 11a (only one illustrated in FIG. 1) positioned to be separated vertically, and a pivot connecting portion 11b positioned in a lower end portion. The pivot connecting portion 11b is provided just below one of the thread supporting portions 11a.

A rear end portion of the light source 12 protrudes backward through the back cover 6. The optical axis adjustment mechanism 13 is constituted with a pivot member 14 and two optical axis adjustment screws 15, 15.

The pivot member 14 includes an axial portion 14a, a connecting portion 14b provided in a front end portion of the axial portion 14a, and a spherical portion 14c provided in a rear end portion of the axial portion 14a. The pivot member 14 is supported such that the connecting portion 14b is connected to the pivot connecting portion 11b of the reflector 11 and the spherical portion 14c is rotatably connected to the pivot supporting portion 2b of the lamp body 2.

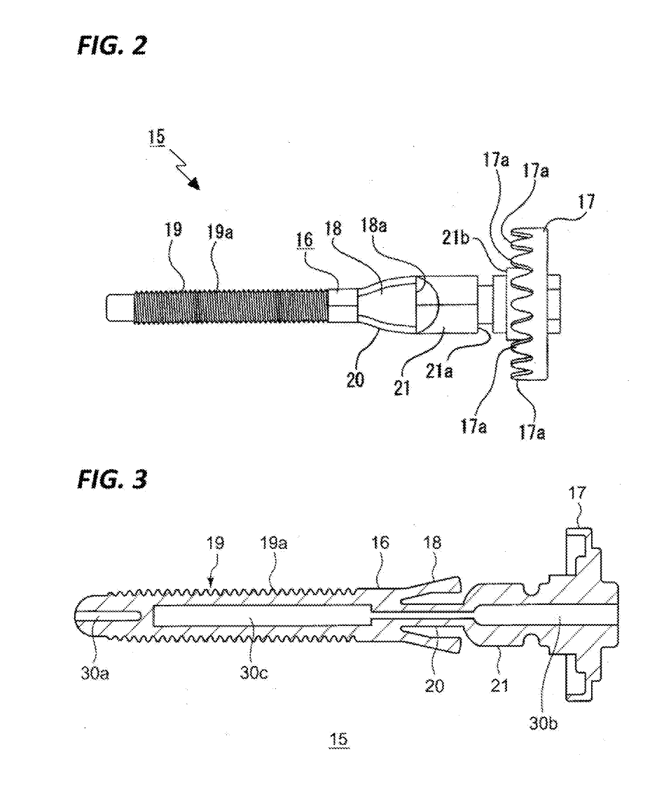

FIG. 2 is a side view illustrating an optical axis adjustment screw, which is an example of a resin molded part according to the present exemplary embodiment. The optical axis adjustment screw 15 is integrally formed by injection molding of a resin using a mold. As illustrated in FIG. 2, the optical axis adjustment screw 15 is constituted with a shaft portion 16 formed in an axial type that extends back and forth, a gear portion 17 that is continuous to a rear end of the shaft portion 16, and a pair of elastic engagement portions 18, 18 that protrude from an outer peripheral surface of the shaft portion 16.

The shaft 16 is provided continuously with a thread forming portion 19, a middle portion 20, and a support shaft portion 21 in this order from the front side. The thread forming portion 19 is formed to have a smaller diameter than that of the support shaft portion 21, and the middle portion 20 is formed such that its diameter increases rearward.

The thread forming portion 19 includes a thread portion 19a formed in a portion excluding its front and rear end portions. The support shaft portion 21 includes a support groove 21a that extends in a circumferential direction. The support shaft portion 21 includes a regulated surface 21b that faces forward, at a rear side of the support groove 21a.

The gear portion 17 protrudes outward from the rear end portion of the shaft portion 16. The gear portion 17 includes gear teeth 17a, 17a, . . . , 17a formed on an outer peripheral portion of its front surface.

Each of the elastic engagement portions 18, 18 is provided to be continuous to the rear end of the thread forming portion 19. Each of the elastic engagement portions 18, 18 is provided to be displaced outward as it goes rearward, and is elastically deformable in a direction connecting to or spaced apart from the outer peripheral surface of the shaft portion 16. The elastic engagement portions 18, 18 include slide contact surfaces 18a, 18a that face rearward, respectively.

The optical axis adjustment screws 15, 15 are rotatably supported to the lamp body 2 (see FIG. 1). As the shaft portion 16 and the elastic engagement portions 18, 18 are inserted into the insert hole 9a of the screw support 7 from the rear side, the optical axis adjustment screw 15 is supported to the lamp body 2. An O-ring 22 is attached to the support groove 21a of the optical axis adjustment screw 15. And, since the O-ring 22 is brought into close contact with an inner peripheral surface of the support cylinder 8 in the screw support 7 in a state where the optical axis adjustment screw 15 is supported to the lamp body 2, moisture is suppressed from entering into the chamber 5 from the insert hole 9a.

When the elastic engagement portions 18, 18 are inserted into the insert hole 9a of the screw support 7, the elastic engagement portions 18, 18 are brought into sliding contact with an opening edge of the insert hole 9a to be elastically deformed in a direction closer to the shaft portion 16. The elastic engagement portions 18, 18 are elastically restored when they are wholly inserted into the insert hole 9a, so that the sliding contact surfaces 18a, 18a are brought into contact with a front surface of the flange 9 in the screw support 7. Accordingly, the optical axis adjustment screw 15 is suppressed from being pulled out from the lamp body 2 to the rear side.

When the optical axis adjustment screw 15 is supported to the lamp body 2, the restrained surface 21b is brought into contact with the restraining surface 8a formed in the support cylinder 8 of the screw support 7. Therefore, the forward movement of the optical axis adjustment screw 15 with respect to the lamp body 2 is restrained. The thread portions 19a, 19a of the optical axis adjustment screws 15, 15 are screwed to the thread supporting portions 11a, 11a of the reflector 11, respectively.

In the vehicle headlamp 1, when the optical axis adjustment screw 15 is rotated by operation, the thread supporting portion 11a is sent in a direction according to a rotation direction of the optical axis adjustment screw 15 (substantially back and forth), and the reflector 11 is tilted with respect to the lamp body 2. The rotation of the optical axis adjustment screw 15 is performed by rotating the gear portion 17 operated by a jig 100 such as, for example, a driver.

When the optical axis adjustment screw 15 positioned at the upper side is rotated, the reflector 11 is tilted in an up-and-down direction with respect to the lamp body 2 about the optical axis adjustment screw 15 positioned at the lower side and the spherical portion 14c of the pivot member 14 as fulcrums, so that the aiming adjustment in the up-and-down direction is performed.

On the other hand, when the optical axis adjustment screw 15 positioned at the lower side is rotated, the reflector 11 is tilted in a right-and-left direction with respect to the lamp body 2 about the optical axis adjustment screw 15 positioned at the upper side and the spherical portion 14c of the pivot member 14 as fulcrums, so that the aiming adjustment in the right-and-left direction is performed.

Conventionally, some parts, including the optical axis adjustment screw, are made of a metal. However, from the viewpoint of the weight lightening or cost reduction, parts manufactured by injection molding of a resin using a mold has been being adopted. Further, since resin parts generally have lower strength than that of metal parts, there is a tendency to increase in size or diameter from the viewpoint of securing strength of the parts. In that case, in order to achieve additional weight lightening, a technique of researching a mold shape to provide a hollow portion inside a part has also been proposed.

FIG. 3 is a schematic cross-sectional view illustrating the optical axis adjustment screw according to the present exemplary embodiment. The optical axis adjustment screw 15 includes mainly three hollow portions 30a, 30b, 30c (not illustrated in FIG. 1). The hollow portions 30a, 30b are regions formed by a mold to be described later, and the hollow portion 30c is a region formed by injecting a gas to the inside of the molten resin in a manufacturing method to be described later.

(Mold for Resin Molded Part)

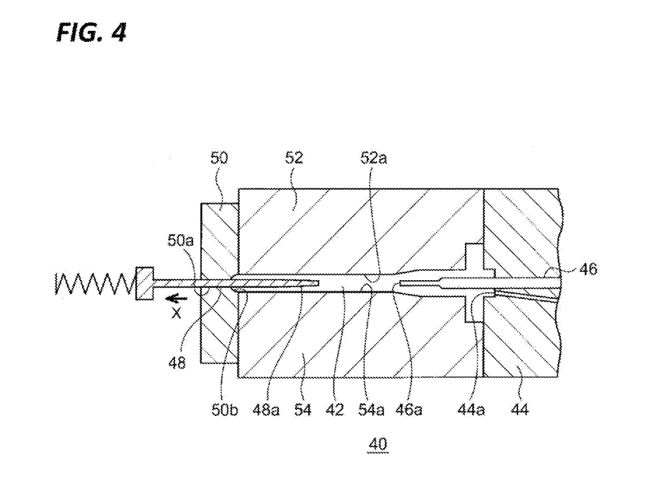

FIG. 4 is a cross-sectional view illustrating a schematic configuration of a mold for a resin molded part (hereinafter, referred to as a “resin molded part mold”) according to the present exemplary embodiment. Further, illustration of the details of the cavity according to the optical axis adjustment screw 15 is appropriately omitted.

The resin molded part mold 40 defines a cavity 42 with a plurality of submolds. The plurality of submolds include a gate submold 44 formed with a gate configured to inject a molten resin into the cavity 42, a gas injection submold 46 formed with a gas injection port 46a configured to inject a gas into the cavity 42, a core pin submold 48 provided with a core pin 48a that is movable in an X direction retreating from the cavity 42, a first submold 50, a second submold 52, and a third submold 54.

The first submold 50 is provided with a through-hole 50a through which the core pin submold 48 is slidably moved, and a recess 50b according to a shape of a front end portion of the optical axis adjustment screw 15. The second submold 52 and the third submold 54 include recesses 52a, 54a mainly according to lateral sides of the optical axis adjustment screw 15, respectively. The core pin submold 48 is arranged such that the core pin 48a faces the gas injection port 46a.

(Manufacturing Method of Resin Molded Part)

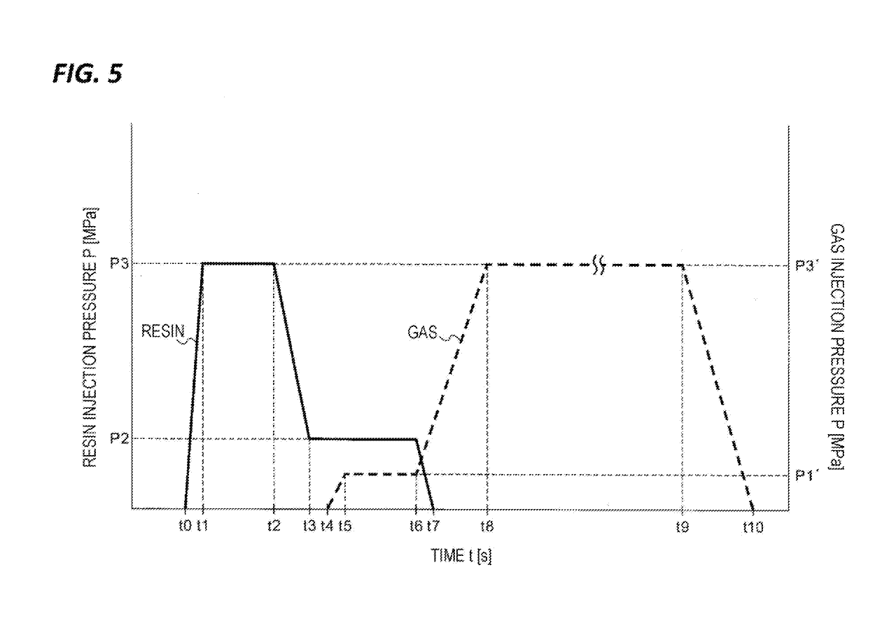

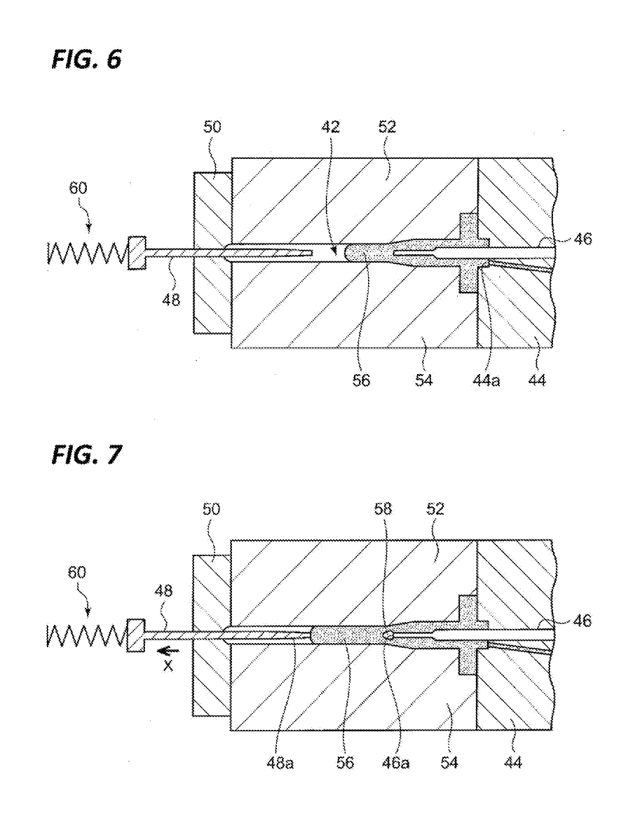

Next, descriptions will be made on a manufacturing method of a part using the above-described mold for a resin molded part. FIG. 5 is a view illustrating a timing chart in a manufacturing method according to the present exemplary embodiment. FIGS. 6 to 10 are cross-sectional views schematically illustrating a state inside the cavity during injection molding.

After the above-described plurality of submolds is clamped, a molten resin 56 is injected from the gate 44a toward the cavity 42 at injection pressure P3 [MPa] at time t0, and the pressure is maintained from time t1 to time t2. In this state, as illustrated in FIG. 6, the molten resin 56 is gradually filled from the rear end (the gate 44a side) of the cavity 42 toward the central portion thereof.

Thereafter, as illustrated in FIG. 7, when the molten resin 56 reaches the front end of the core pin 48a, the core pin 48a is gradually retreated in the direction X by being pushed by the molten resin 56. Before and after this timing, the injection pressure P is decreased to P2 [MPa] (time t3) and the injection pressure P is maintained at P2 (time t3 to time t6). Therefore, a supply amount of the molten resin 56 is reduced, as compared with that until the time.

Further, a gas 58 is injected from the gas injection port 46a toward the inside of the molten resin 56 at injection pressure P1′ [MPa] before and after time t3 (t4 in the present exemplary embodiment), and maintained at a constant pressure (pressure P1′) (time t5 to time t6). Nitrogen or air is used as the gas 58. Thereafter, the hollow portion 30c filled with the gas 58 is further expanded by increasing the injection pressure of the gas to P3′ (time t6 to time t8), so that the molten resin 56 in the cavity 42 is moved while further pushing the core pin 48a. Further, the injection pressure P of the molten resin 56 is reduced since time t6, and the injection is stopped at time t7. Further, the gas injection pressure P3′ is about 1/10 of the resin injection pressure P3.

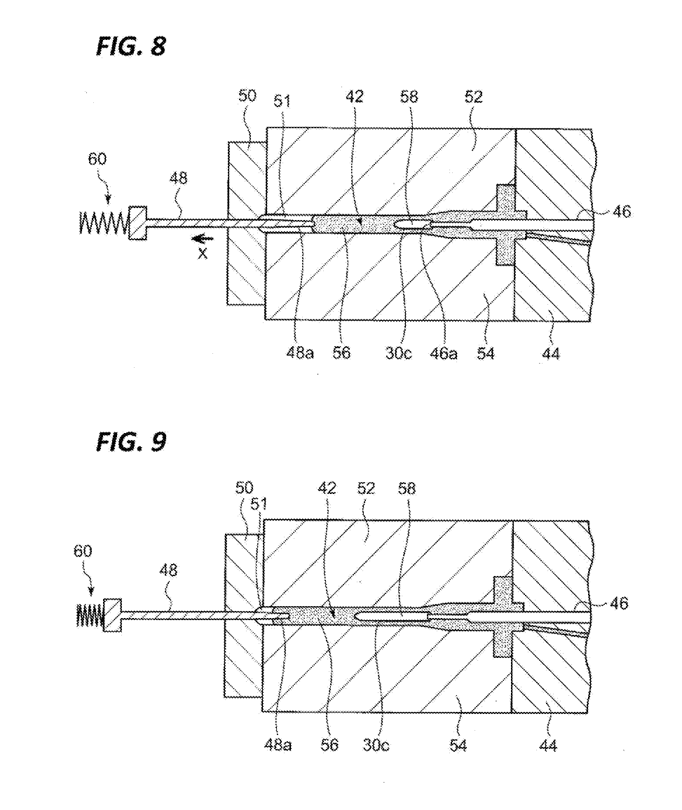

When the core pin 48a is retreated from the cavity 42, the pressure in the cavity 42 is reduced. Therefore, the molted resin 56 is further moved forward toward an unfilled region while pushing the core pin 48a. At the same time, the hollow portion 30c is also formed toward the core pin 48a side by the expansion of the gas 58 (see FIG. 8).

Then, as illustrated in FIG. 9, while the core pin 48a is retreated to a predetermined position where it cannot be moved anymore, the molten resin 56 is further moved forward by the supplied gas 58 while covering the periphery of the core pin 48a. At the same time, the hollow portion 30c is expanded by the injection of the gas 58, so that the hollow portion 30c is formed while further extending toward the core pin 48a side.

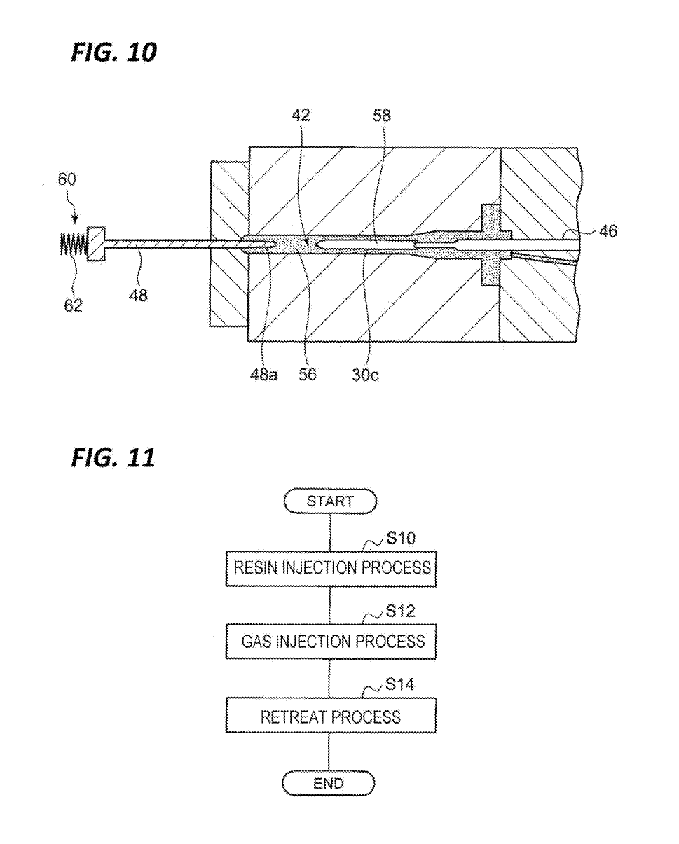

Thereafter, as illustrated in FIG. 10, the molten resin 56 fills a gap where the cavity 42 remains, with the expansion of the gas 58. Further, the hollow portion 30c is formed to be broader toward the core pin 48a by the expansion of the gas 58.

Thus, as compared with a case of a mold in which a core pin is not moved, in the resin molded part mold 40 according to the present exemplary embodiment, the core pin 48a is moved in the direction X retreating from the cavity 42 at a predetermined timing, so that the pressure of the resin-unfilled space 51 (see FIGS. 8 and 9) in the cavity is reduced and the expansion of the hollow portion 30c formed inside the molten resin 56 by the gas 58 is facilitated. Therefore, the hollowness of the optical axis adjustment screw 15, which is a kind of resin molded parts, may be enhanced.

Further, the core pin submold 48 includes a moving mechanism 60 configured to retreat the core pin 48a in the direction X spaced apart from the gas injection port 46a and the gate 44a. The moving mechanism 60 is not particularly limited as long as the core pin 48a is configured to be retreated by the molten resin 56 injected into the cavity 42.

For example, the moving mechanism 60 according to the present exemplary embodiment is configured to use a force in which the molten resin 56 pushes the core pin 48a, and a spring member 62 biases the rear end of the core pin submold 48 (the opposite side of the core pin 48a). Thus, since the pressure of the molten resin 56 injected in the cavity 42 is used as a force of retreating the core pin 48a, the core pin 48a may be retreated by a simple mechanism. Further, a driving mechanism such as, for example, an air cylinder or a motor may be used instead of the spring member 42.

Further, the resin molded part mold 40 is configured such that the gate 44a and the gas injection port 46a are arranged at one end in a length direction of the cavity 42 according to the shape of the resin molded part, and the core pin 48a is arranged at the other end thereof.

It is also considered that the resin molded part mold 40 according to the present exemplary embodiment defines the cavity with a fixed submold and a movable submold. The fixed submold may be constituted with one or more molds. For example, the gate submold 44 and the gas injection submold 46 may be formed integrally. In addition, the movable submold may also be constituted with one or more molds. Specifically, the fixed submold of the resin molded part mold 40 is constituted with the gate submold 44, the gas injection submold 46, the first submold 50, the second submold 52, and the third submold 54. Further, the moving submold of the resin molded part mold 40 is constituted with the core pin submold 48.

(Method of Manufacturing Resin Molded Part)

FIG. 11 is a flowchart illustrating a method of manufacturing the resin molded part according to the present exemplary embodiment. The method includes: a resin injection process S10 of injecting the molten resin 56 into the cavity 42 that is defined with the gate submold 44, the gas injection submold 46, the core pin submold 48, the first submold 50, the second submold 52, and the third submold 54; a gas injection process S12 of injecting the gas 58 into the molten resin 56 before the cavity 42 is fully filled with the molten resin 56; and a retreat process S14 of retreating at least a part of the core pin 48a in the cavity 42 from the cavity 42 after the gas injection process is started and before the cavity 42 is fully filled with the molten resin 56.

According to the manufacturing method, when the core pin 48a is moved in the retreat direction from the cavity 42, a hollow portion 30c formed in the molten resin 56 by the gas 58 is expanded. Therefore, the hollowness of the resin molded part may be enhanced.

Further, the retreat process may be performed in a situation where the molten resin 56 has fluidity. Accordingly, the hollow portion 30c formed in the molten resin 58 by the gas 58 is easily expanded.

The above-described technique is suitable for a high-aspect ratio (elongated) part. For example, it is suitable for a part having an aspect ratio of 3 or more, 5 or more, or 8 or more. Further, in a case of a part having a complicated shape such as the optical axis adjustment screw 15 according to the present exemplary embodiment, the diameter (width), which is a standard of the aspect ratio, may be based on, for example, the thread forming portion 19 or the shaft portion 16, or may be based on other parts.

The longer optical axis adjustment screw 15 allows an aiming adjustment operation at a position far away from the vehicle headlamp 1. Meanwhile, when the optical axis adjustment screw 15 is long, it is not easy to form a hollow portion inside the part. For example, the hollow portion may be formed to be long by lengthening the core pin, but the core pin is easily broken. Further, there is an idea to increase the injection amount or the pressure of the gas such that the gas reaches the front end of the part. However, when the gas pressure is too high or the gas injection time is too long, the injection molding or cooling after the molding may be adversely affected. The above-described technique is suitable as an idea to solve the problems.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A mold for a resin molded part which defines a cavity with a plurality of submolds, wherein the plurality of submolds includes:
a gate submold including a gate formed therein to inject a molten resin into the cavity;
a gas injection submold including a gas injection port formed therein to inject a gas into the cavity; and
a core pin submold including a core pin provided to be movable in a retreat direction from the cavity, and
the core pin submold is arranged such that the core pin faces the gas injection port.

2. The mold of claim 1, wherein the core pin submold includes a moving mechanism configured to retreat the core pin in a direction away from the gas injection port and the gate.

3. The mold of claim 2, wherein the moving mechanism is configured such that the core pin is retreated by the molten resin injected into the cavity.

4. The mold of claim 1, wherein the gate and the gas injection port are arranged at one end of the cavity in a length direction according to the shape of the resin molded part, and the core pin is arranged at the other end thereof.

5. The mold of claim 2, wherein the gate and the gas injection port are arranged at one end of the cavity in a length direction according to the shape of the resin molded part, and the core pin is arranged at the other end thereof.

6. The mold of claim 3, wherein the gate and the gas injection port are arranged at one end of the cavity in a length direction according to the shape of the resin molded part, and the core pin is arranged at the other end thereof.

7. A mold for a resin molded part which defines a cavity with a fixed submold and a movable submold, wherein the fixed submold includes a gate formed to inject a molten resin into the cavity, and a gas injection port formed to inject a gas into the cavity,
the movable submold is provided with a core pin to be movable in a retreat direction from the cavity, and
the core pin is arranged to face the gas injection port.

8. A method of manufacturing a resin molded part, the method comprising:
injecting a molten resin into a cavity that is defined with a plurality of submolds;
injecting a gas into the molten resin before the cavity is filled with the molten resin; and
retreating at least a part of the core pin in the cavity from the cavity after the injecting is started and before the cavity is filled with the molten resin.

9. The method of claim 8, wherein the retreating is performed in a situation where the molten resin has fluidity.
